(19) United States
(12) Patent Application Publication
(10) Pub. No.: US 2020/0294780 A1
(43) Pub. Date: Sep. 17, 2020

(54) COMBINED HEATING AND POWER MODULES AND DEVICES

(71) Applicant: Modern Electron, LLC, Bothell, WA (US)

(72) Inventors: Justin B. Ashton, Palo Alto, CA (US); Stephen E. Clark, Issaquah, WA (US); William Kokonaski, Edmonds, WA (US); Daniel Kraemer, Kirkland, WA (US); John J. Lorr, Redmond, WA (US); Max N. Mankin, Seattle, WA (US); David J. Menacher, Evanston, IL (US); Patrick D. Noble, Seattle, WA (US); Tony S. Pan, Bellevue, WA (US); Ad de Pijper, Redmond, WA (US); Lowell L. Wood, Bellevue, WA (US)

(73) Assignee: Modern Electron, LLC, Bothell, WA (US)

(21) Appl. No.: 16/814,930

(22) Filed: Mar. 10, 2020

Related U.S. Application Data
(63) Continuation of application No. 16/794,142, filed on Feb. 18, 2020.
(60) Provisional application No. 62/818,598, filed on Mar. 14, 2019.
(60) Provisional application No. 62/817,459, filed on Mar. 12, 2019.

(51) Int. Cl. H01J 45/00

(52) U.S. Cl. CPC H01J 45/00

(57) ABSTRACT

Various disclosed embodiments include combined heating and power modules and combined heat and power devices. In an illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one thermionic energy converter has a hot shell and a cold shell, the hot shell being thermally couplable to the at least one burner, the cold shell being thermally couplable to the heat exchanger.

### RELATED APPLICATIONS

The present application claims the benefit of priority of filing from U.S. Provisional Patent Application Ser. No. 62/817,459, filed Mar. 12, 2019, and entitled “Combined Heat And Power System With Thermionic Device,” the entire contents of which are incorporated by reference, and U.S. Provisional Patent Application Ser. No. 62/818,598, filed Mar. 14, 2019, and entitled “Integration Of A Thermionic Generator With Heat Exchangers In A Combined Heat And Power Device,” the entire contents of which are incorporated by reference.

### TECHNICAL FIELD

The present disclosure relates to combined heat and power systems.

### BACKGROUND

The statements in this section merely provide background information related to the present disclosure and may not constitute prior art.

Combined heat and power (“CHP”)—also known as co-generation—refers to the generation of heat and electrical power in the same device or location. In CHP, excess heat from local electrical power generation is delivered to the end-user, thereby resulting in higher combined efficiency than separate electrical power and heat generation. Because of the improvement in overall efficiency, CHP can offer energy cost savings and decreased carbon emissions.

Micro-CHP involves devices producing less than approximately 50 kW of electricity. Micro-CHP has not been widely adopted at power levels of less than approximately 5 kW electricity, despite the vast majority of households in North America and Europe having average demand of 1 kW of electricity or less. This limitation in adoption of micro-CHP is based on a combination of technology and economics. For example, no currently known technology offers a suitable combination of the following characteristics at scales below approximately 5 kW: low capital cost; low or no noise (that is, silent operation); no maintenance for long periods of time; ability to ramp on/off quickly to follow heat usage loads; competitive efficiencies at small scales ; and integrability with home heating appliances such as furnaces (for heating air), boilers/water heaters (for heating water), and/or absorption chillers (for providing cooling) (known as “heating units” or “home heating appliances” or the like).

CHP works in two modes. One mode is heat-following mode, in which generating heat is the primary function of the system and electricity is produced whenever heat is in demand by diverting some of the heat into the production of electricity. The other mode is electricity-following, in which the principle function of the system is to produce electricity and the heat produced in the process of generating the electricity is captured for another useful purpose, such as heating water or providing heat for a secondary process.

The higher the utilization rate (that is, on-time) of the electricity generator, the better the economic payback for a micro-CHP unit in heat-following mode. It is desirable to balance the heat load and the demand for electricity. In a CHP device, it is also desirable to transfer waste heat efficiently from the heat engine to air or water. Efficient heat transfer can entail high-quality heat exchangers as well as good thermal/mechanical coupling between the heat engine and the heat exchangers.

### SUMMARY

Various disclosed embodiments include combined heating and power modules and combined heat and power devices.

In an illustrative embodiment, a combined heat and power module includes at least one burner. At least one thermionic energy converter is attached to the at least one burner, the at least one thermionic energy converter having a hot shell and a cold shell, the hot shell being configured to be thermally couplable to the at least one burner, the cold shell being configured to be thermally couplable to a heat exchanger.

In another illustrative embodiment, a combined heat and power module includes at least one burner. At least one thermionic energy converter has a hot shell and a cold shell, and the hot shell is configured to be thermally couplable to the at least one burner. A heat exchanger is configured to be thermally couplable to the cold shell. Each one of the at least one burner and the at least one thermionic energy converter and the heat exchanger is attached to at least one other of the at least one burner and the at least one thermionic energy converter and the heat exchanger.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one thermionic energy converter has a hot shell and a cold shell, the hot shell being thermally couplable to the at least one burner, the cold shell being thermally couplable to the heat exchanger.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one thermionic energy converter has a hot shell and a cold shell, the hot shell being thermally couplable to the at least one burner, the cold shell being thermally couplable to the heat exchanger. An electrical battery is electrically connectable to the at least one igniter and the prime mover.

In another illustrative embodiment, a combined heat and power device includes a heating system including: at least one burner; at least one igniter configured to ignite the at least one burner; a fluid motivator assembly including an electrically powered prime mover; and a heat exchanger fluidly couplable to the fluid motivator assembly. At least one thermionic energy converter has a hot shell and a cold shell, the hot shell being thermally couplable to the at least one burner, the cold shell being thermally couplable to the heat exchanger. The thermionic energy converter is electrically couplable to the prime mover.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1A is schematic illustration of an illustrative combined heat and power module.

FIG. 1B is a perspective view of an illustrative combined heat and power module.

FIG. 1C is a perspective view of another illustrative combined heat and power module.

FIG. 1D is a side plan view in partial schematic form of illustrative burner tubes.

FIG. 1E is a cutaway side plan view of an illustrative combined heat and power module.

FIG. 1F is a cutaway side plan view in partial schematic form of an illustrative swirling combustion chamber.

FIG. 1G is schematic illustration of another illustrative combined heat and power module.

FIG. 1H is a cutaway side plan view of an illustrative combined heat and power module.

FIG. 1I is a cutaway side plan view of another illustrative combined heat and power module.

FIG. 1J is a cutaway side plan view of another illustrative combined heat and power module.

FIG. 1K is a cutaway side plan view of another illustrative combined heat and power module.

FIG. 1L is a cutaway side plan view of an illustrative combined heat and power module.

FIG. 1M is an exploded perspective view of the combined heat and power module of FIG. 1L.

FIG. 2A is cutaway side plan view of an illustrative thermionic energy converter.

FIG. 2B is cutaway end plan view of the thermionic energy converter of FIG. 2A.

FIG. 2C is cutaway side plan view of another illustrative thermionic energy converter.

FIG. 2D is a side plan view in partial cutaway of an arrangement of thermionic energy converters of FIG. 2C.

FIG. 2E is cutaway side plan view of another illustrative thermionic energy converter.

FIG. 2F is cutaway side plan view of another illustrative thermionic energy converter.

FIG. 2G is cutaway side plan view of another illustrative thermionic energy converter.

FIG. 2H is cutaway side plan view of another illustrative thermionic energy converter.

FIG. 2I is cutaway side plan view of another illustrative thermionic energy converter.

FIG. 2J is cutaway side plan view of another illustrative thermionic energy converter.

FIG. 3A is schematic illustration of another illustrative combined heat and power module.

FIGS. 3B, 3C, and 3D illustrate details regarding thermal coupling of cold shells and heat exchangers.

FIG. 3E is a side plan view in partial schematic form of another illustrative combined heat and power module.

FIG. 3F is a side plan view in partial schematic form of another illustrative combined heat and power module.

FIG. 4A is a block diagram of an illustrative combined heat and power device.

FIG. 4B is a cutaway side plan view of an illustrative combined heat and power device embodied as a furnace.

FIG. 4C is a cutaway side plan view of an illustrative combined heat and power device embodied as a boiler.

FIG. 4D is a cutaway side plan view of an illustrative combined heat and power device embodied as a condensing boiler.

FIG. 4E is a cutaway perspective view of an illustrative combined heat and power device embodied as a water heater.

FIG. 4F is a block diagram of details of the combined heat and power device of FIG. 4A.

FIG. 4G is a graph of current versus voltage for a thermionic energy converter.

FIG. 5 is a block diagram of an illustrative combined heat and power device embodied as a backup generator.

FIG. 6 is a block diagram of an illustrative combined heat and power device embodied as a self-powering appliance.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

By way of overview, various disclosed embodiments include combined heating and power modules and combined heat and power devices. As will be explained in detail below, in various embodiments illustrative combined heating and power modules include, among other things, at least one thermionic energy converter and are suited to be disposed in a heating appliance such as, for example, a furnace, a boiler, or a water heater. As will also be explained in detail below, in various embodiments illustrative combined heating and power devices include, among other things, at least one thermionic energy converter and are suited for use as a heating appliance such as, for example, a furnace, a boiler, or a water heater. Thus, it will be appreciated that various embodiments can help contribute to seeking to increase the electricity:heat ratio in a combined heat and power (“CHP”) or co-generation device.

Now that a non-limiting overview has been given, details will be explained by way of non-limiting examples given by way of illustration only and not of limitation.

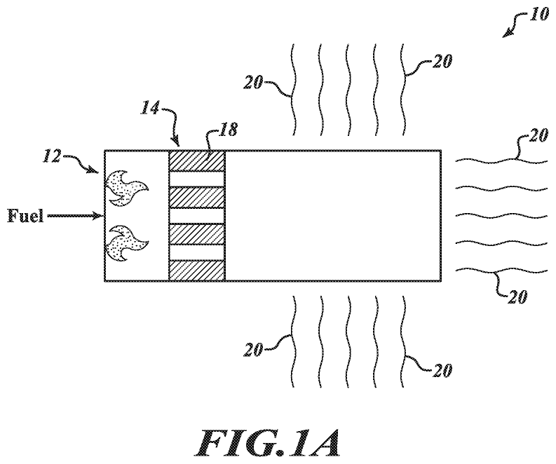

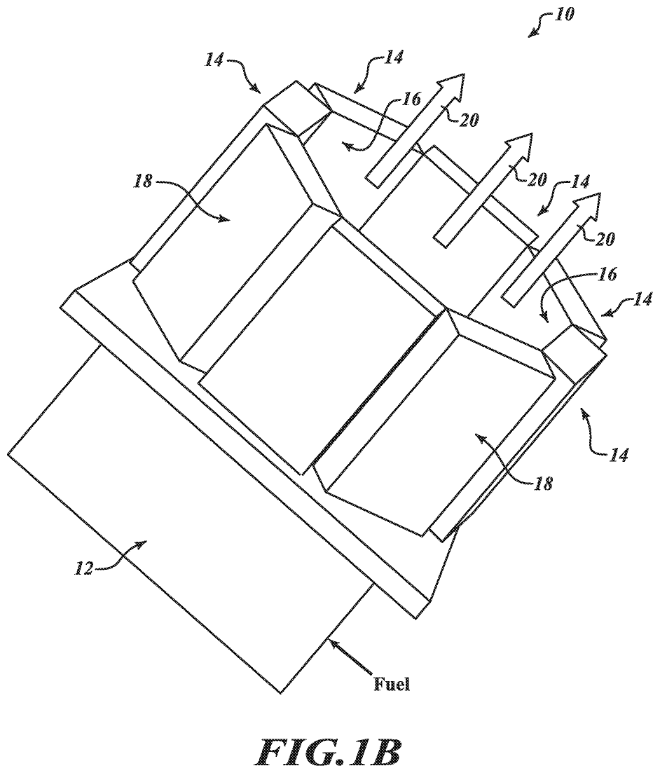

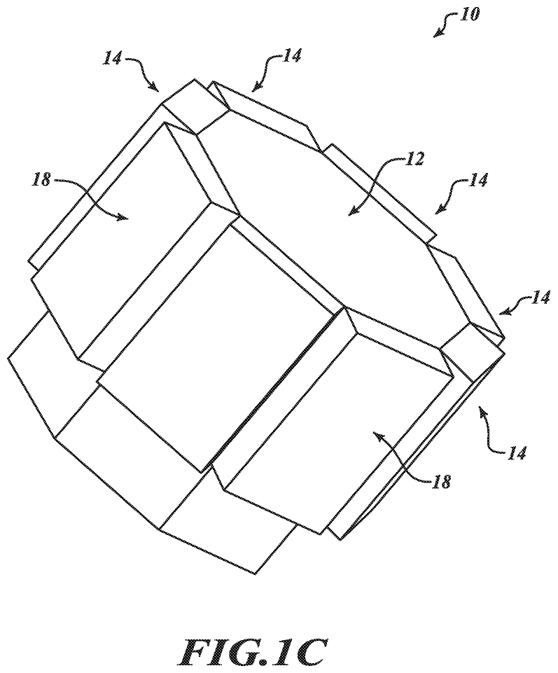

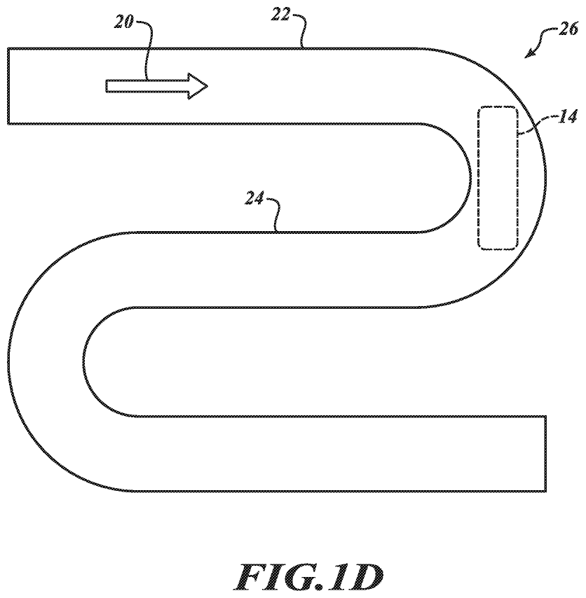

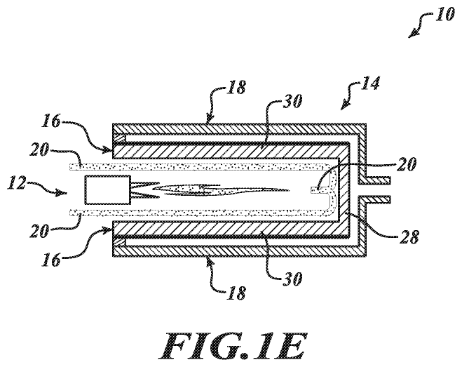

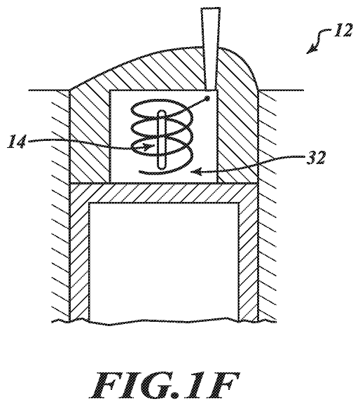

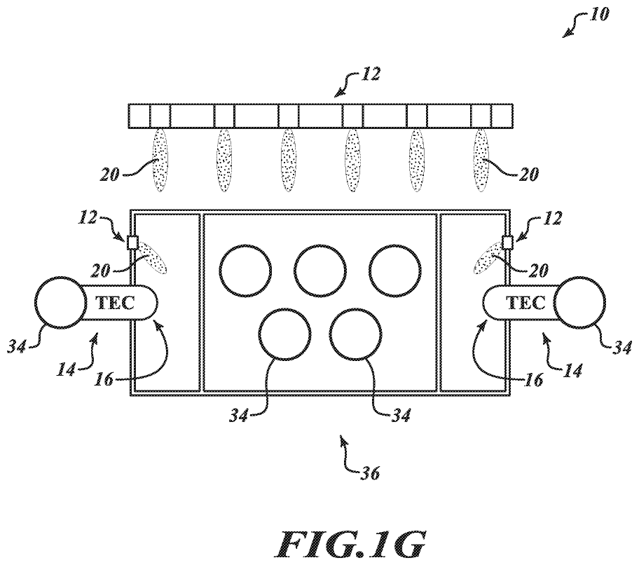

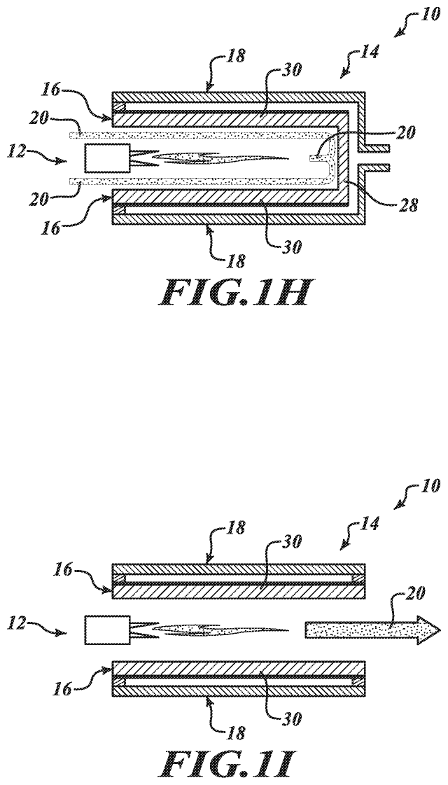

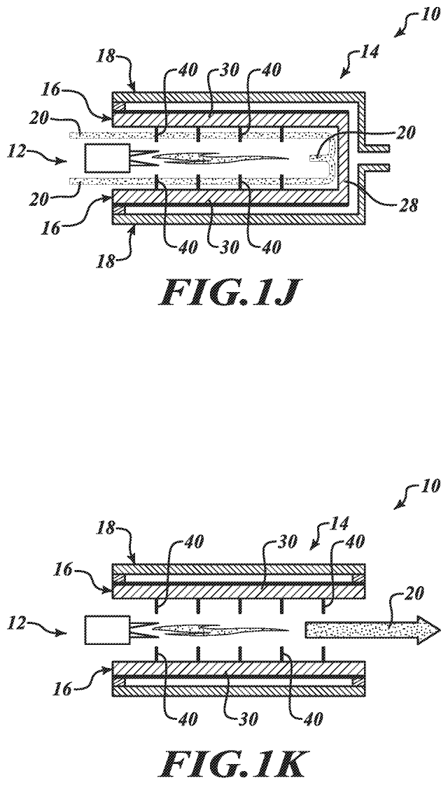

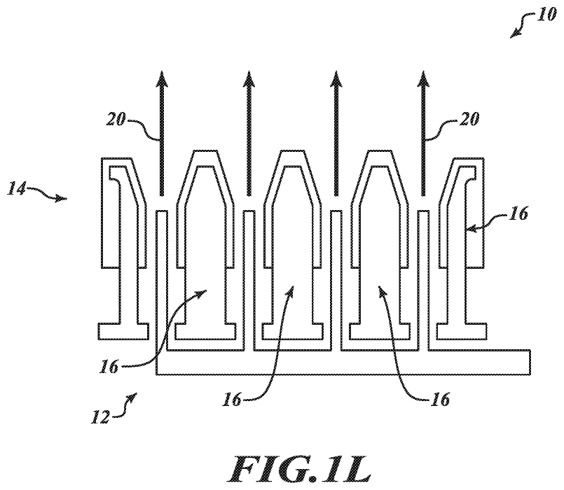

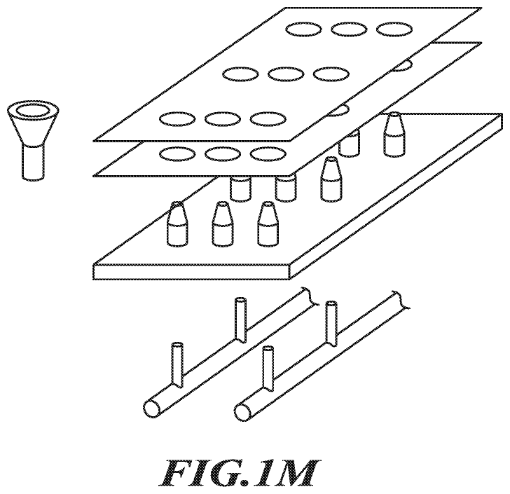

Referring to FIGS. 1A-1C, in various embodiments an illustrative combined heat and power module 10 includes at least one burner 12. At least one thermionic energy converter 14 is attached to the burner 12. The thermionic energy converter 14 has a hot shell 16 (FIG. 1B) and a cold shell 18. The hot shell 16 is configured to be thermally couplable to the burner 12 and the cold shell 18 is configured to be thermally couplable to a heat exchanger (not shown).

It will be appreciated that, because the cold shell 18 is configured to be thermally couplable to a heat exchanger, the module 10 is suited for use in a heating appliance such as, without limitation, a furnace, a boiler, or a water heater in settings such as a residence or a commercial building, and can help contribute to increasing overall system efficiency by helping to use waste heat from the cold shell 18 that may be thermally couplable to a heat exchanger in a heating appliance.

Thus, it will be appreciated that the module 10 can replace an existing boiler or gas furnace burner and can thereby allow an existing boiler/gas-furnace to be retrofitted to a combined heat and power device. The functional surfaces of the thermionic energy converter 14 (that is, the surfaces that emit and collect the electrons) can be formed to maximize power production and minimize the overall volume of the thermionic energy converter 14. In addition, the burner 12 can be designed to work at the same gas and air pressure as the existing burner, thereby allowing the inlet fuel pressure and air delivery system of existing boiler/gas furnaces to be used. By creating an exhaust stream that is similar to that of the existing burner (such as, for example, flow, temperature, exhaust manifold size and connections), no further changes need be made to an existing boiler/gas furnace.

It will be appreciated that operating temperature of the hot shell 16 is high. Because of its high temperature, the hot shell 16 can lose a significant amount of energy to an appliance's environment (typically walls of a heat exchanger) through radiation. This loss can be a challenge especially for the walls of the heat exchanger that do not face the flame.

To help contribute to reducing heat loss from the side of the hot shell 16, in some embodiments the hot shell 16 is surrounded with other thermionic energy converters 14. Because the temperature of these thermionic energy converters 14 is also high, the amount of radiation loss is reduced.

As shown in FIG. 1B, in various embodiments the burner 12 may include a nozzle burner for use with oil as fuel or a venturi burner for use with natural gas or propane as fuel. In such embodiments, flame from the burner 12 is indicated by arrows 20. In some such embodiments and referring additionally to FIG. 1D, the burner 12 may include a first-pass tube 22 and a second-pass tube 24 interconnected by an elbow 26. It will be appreciated that in gas furnace systems there are two distinct locations with the highest heat release from the flame to the process air: close to the burner 12; or in the elbow 26 that connects the first-pass tube 22 and the second-pass tube 24. In such embodiments, the thermionic energy converter 14 is disposed in the elbow 26. The reason for the increased heat release in the elbow 26 is that the change of direction of the gas flow increases the mixing of air and unburned fuel. Also, there is increased impingement and scrubbing/breakdown of the boundary layer of air that is typically between the flame and the tube.

Referring additionally to FIG. 1E, in some embodiments the burner 12 may include a single-ended recuperative burner. In such embodiments, air and fuel (as indicated by the arrows 20) flows out of the burner 12 toward an end wall 28 of the hot shell 16, whereupon the flame is redirected back toward the burner 12 in thermal communication with side walls 30 of the hot shell 16.

As shown in FIG. 1C, in some embodiments the burner 12 may include a porous burner.

It will be appreciated that any numbers of burners 12 may be used in the module 10 as desired for a particular application. For example, in some embodiments the module 10 may include no more than one burner 12. However, in some other embodiments the module 10 may include more than one burner 12.

In various embodiments the burner 12 may be configured to combust with preheated air/fuel (that is, recuperation of enthalpy of exhaust gas of the burner 12 by preheating air/fuel) or using an enrichment agent such as oxygen-enriched air or hydrogen-enriched combustion. In some such embodiments, flame temperatures—and thus potentially cathode temperatures—can be increased by firing with preheated air/fuel or oxygen-enriched air to aid with the hot-side heat transfer. Given by way of non-limiting example, firing with oxygen-enriched air can be accomplished by use of an oxygen concentrator/enrichment system and using this oxygen in the input stream of the burner 12. It will be appreciated that pure oxygen need not be used. For example, with use of pressure-swing-absorption-processed air (“PSA”), as little as two-fold boosting of oxygen concentration may be adequate to accomplish firing with oxygen-enriched air. Given by way of another non-limiting example, a “rapid PSA” device (that operates more isentropically) may be used as desired for a particular application. It may also be desirable to exhaust such relatively high-temperature gases quasi-adiabatically—and/or over a suitably-catalytic surface—in order to suppress NOx emissions. It will be appreciated that use of oxygen in the flame in some operating conditions can also have the effect of lowering NOx emissions despite the increased flame temperature (due to proportionally lower availability of N2 from air).

In some other such embodiments, hydrogen-enriched combustion may also result in higher flame temperatures which will help with hot-side heat transfer. In such embodiments, hydrogen-enriched combustion can be accomplished by including a device upstream on the fuel line that cracks incoming fuel (such as natural gas or methane) into hydrogen, thereby leaving behind carbon. This hydrogen is fed into the flame to raise flame temperature, thereby enhancing heat transfer from the flame to the thermionic energy converter 14. The hydrogen may be readily sourced by thermal decomposition of the inputted natural gas (or methane) stream. It will be noted that methane is thermo-fragile and reasonably-readily decomposes into elemental carbon and molecular hydrogen. Given by way of non-limiting example, a suitable arrangement can include a microfinned heat exchange through which the methane is flowed toward the eventual combustion-region, with its hot side heated by exhausted combustion gas. Natural gas thereby refined from (most all of) its carbon content is then burned as a stream of relatively-pure hydrogen, with the carbon remaining behind in the cracking unit. It will be appreciated that, as in the oxygen-enriched air case, pure hydrogen need not be used. In some embodiments, this cracking unit may be regenerated periodically—that is, its accumulated carbon-load removed—by valving heated air (and perhaps a small amount of natural gas for ignition purposes) through it, thereby recovering the latent heat of the carbon for use downstream (for example, the primary space-or-water-heating purposes)—with a twin cracking unit being exercised in its place during this alternating split-cycle operation. Thus, in such embodiments higher temperature flame can be produced than a classic near-stoichiometric hydrogen-oxygen.

In some other embodiments, instead of fully decomposing natural gas or methane and removing carbon content for pure hydrogen combustion, preheating and decomposing the fuel (such as natural gas, methane, or propane) without carbon removal can lead to an enhancement in flame emittance which can help enhance hot-side/flame heat transfer by radiation to the thermionic energy converter 14 and can help limit localized flame hot-spots and, therefore, NOx emissions.

In some embodiments exhaust gas from the burner 12 is directable over surfaces of the thermionic energy converter 14 across an extended path length and with higher velocity by using a swirling flow of the hot flue gas. That is, in such embodiments the burner 12 is arranged such that exhaust gas from the burner 12 is directable over surfaces of the thermionic energy converter 14 in a spiralling path which is a longer path length than a straight pass over the surface of the thermionic energy converter 14. Given by way of non-limiting example and referring additionally to FIG. 1F, in some embodiments a swirler 32 (also known as a swirl combustion chamber or a turbulence combustion chamber) may be configured to direct exhaust gas from the burner 12 over surfaces of the thermionic energy converter 14 over an extended path length at a higher velocity. In such embodiments, the intake air is swirled and the fuel is injected in the swirled air so that mixing and burning of the fuel takes place more completely. This arrangement provides a longer path length at increased flow velocity of the hot gas over the thermionic energy converter 14, thereby helping contribute to an enhanced heat transfer.

Referring additionally to FIG. 1G, in some embodiments the burner 12 may be configured for substantially stoichiometric combustion. In some such embodiments it may be advantageous to burn additional fuel (and, in some cases, possibly air) close to the hot shell 16 and closer to the stoichiometric mixture for enhanced heat transfer (that is, a higher flame temp). Because in some instances the thermionic energy converter 14 may only be using a small amount (such as around five percent or so) of the total thermal power of a heating appliance such as a furnace or boiler, it is possible that the NOx increase is not significant enough to impact the rating of the systems. In some instances, only the portion of the burner 12 that provides the majority of the thermal power for heating the water (in a boiler or water tank) or the air (in a furnace) could run slightly leaner to reduce NOx to accommodate for the localized increase in NOx at or near the surface of the hot shell 16. It is noted that while tubes 34 of a heat exchanger 36 and heat exchanger tubes 38 (for transferring heat from the cold shell 18) are shown in FIG. 1G to illustrate a non-limiting example, it will be appreciated that the tubes 34, the heat exchanger 36, and the heat exchanger tubes 38 are not part of the module 10.

Referring additionally to FIGS. 1H-1K, in some embodiments at least a portion of the hot shell 16 and/or a component 40 that is thermally coupled to the hot shell 16 may be located in the exhaust stream 20 from the burner 12. Given by way of non-limiting examples, the component 40 may be a fin, a formed shape, or the like. It will be appreciated that a part can be placed into the flame/exhaust stream in order to increase the heat flux from a combustion process to the emitter of a thermionic converter. The addition of this part and heating of it by a flame will extract energy from the flame and thereby lower the flame temperature. This part may include an extension of the hot shell 16, a fin, or the entire surface of the hot shell 16. The NOx emission from a flame is a function of the temperature. Therefore, locating this part in the exhaust stream 20 may lower the total NOx emission from the combustion process.

Referring additionally to FIG. 1L, in another embodiment the burner 12 and the hot shell 16 are combined. In such embodiments, it will be appreciated that combustion is made to take place on the surface of the emitter of the thermionic energy converter 14. Referring additionally to FIG. 1M, this design suitably can be assembled from plates and stamped parts.

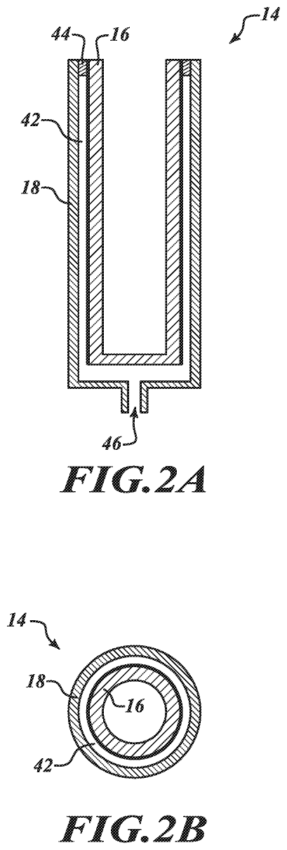

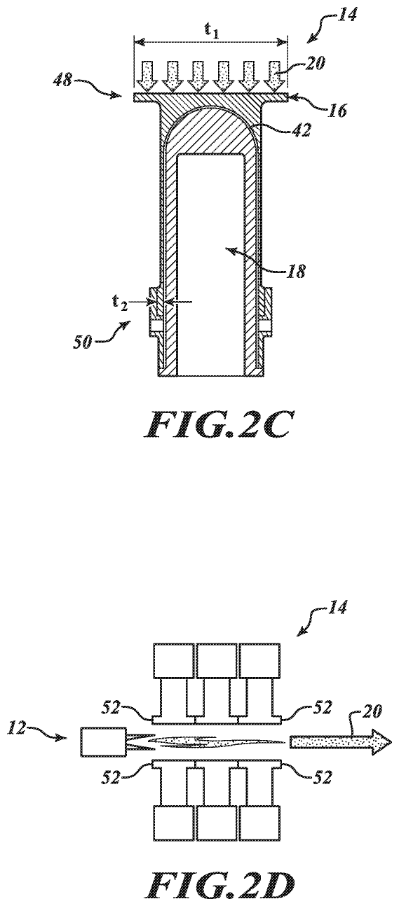

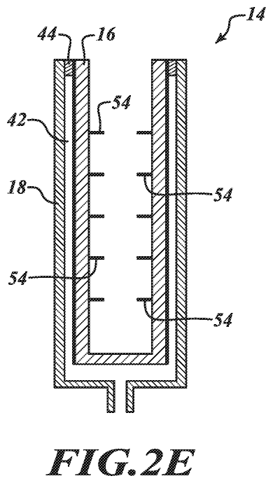

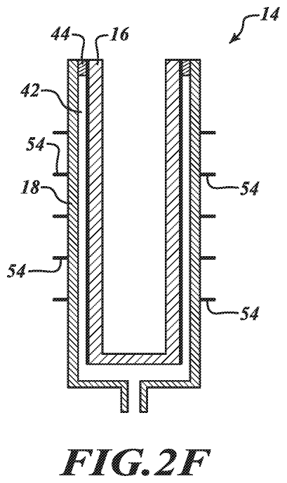

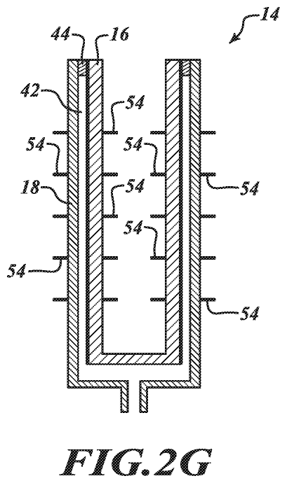

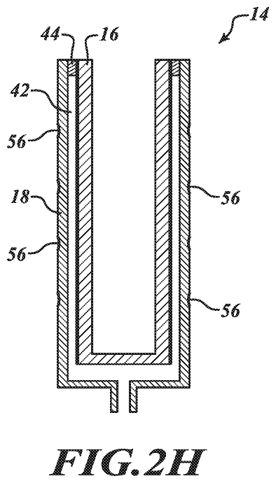

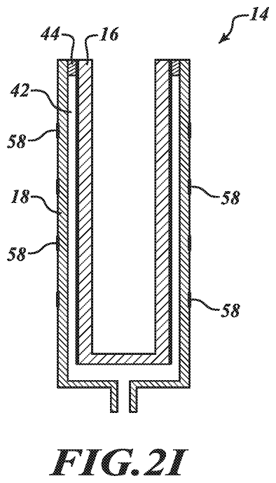

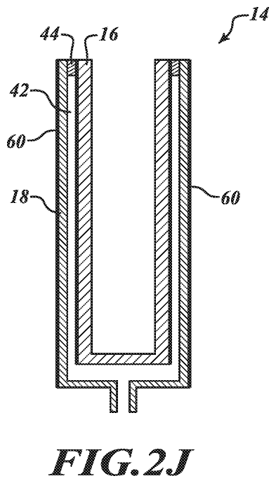

As discussed above, the thermionic energy converter 14 includes the hot shell 16 and the cold shell 18. Referring additionally to FIGS. 2A and 2B, in various embodiments the thermionic energy converter 14 includes a vacuum envelope 42. In such embodiments the vacuum envelope is defined by the hot shell 16, the cold shell 18, and a hermetic seal 44 disposed between the hot shell 16 and the cold shell 18. In some embodiments the thermionic energy converter 14 includes a cesium reservoir 46.

As is known, the thermionic energy converter 14 directly produces electrical power from heat by thermionic electron emission. To that end, the thermionic energy converter 14 includes a hot emitter electrode (not shown)—that is thermally coupled to the hot shell 16—which thermionically emits electrons over a potential energy barrier and through an inter-electrode gap in the vacuum envelope 42 to a cooler collector electrode (not shown)—that is thermally coupled to the cold shell 18, thereby producing a useful electrical power output. In some instances, it may be desirable to use cesium vapor (supplied by the cesium reservoir 46) to help contribute to optimizing electrode work functions and/or an inert gas (such as argon or xenon) to provide an ion supply to help contribute to neutralizing electron space charge.

It will be appreciated that the vacuum envelope 42 suitably helps to: (i) maintain the vacuum between cathode and anode with the hermetic seal 44; (ii) maintain the temperature difference and gap between the cathode and anode; (iii) integrate all components with cesium vapor (to control and/or adjust electrode work function as desired); (iv) reduce heat transfer (conduction and radiation) between hot and cold; and (v) arrange thermionic cells in series to boost output voltage.

It will be appreciated that in various embodiments total power can be increased by optimizing low work function chemistry and plasma process and/or by increasing diameter and/or length and/or overall surface area of the power producing active area. It will also be appreciated that in various embodiments efficiency can be increased by increasing length of a heat rejection zone to reduce heat conduction through the envelope walls and/or by reducing radiation heat transfer in the vacuum envelope 42 and/or by increasing the interelectrode gap to reduce inert gas conduction losses and help contribute to optimizing the plasma process

Operation of thermionic energy converters is well known and, as a result, further explanation is not necessary for an understanding of disclosed subject matter.

In various embodiments, the thermionic energy converter 14 has an electrical power output capacity of no more than 50 kWe. In some such embodiments, the thermionic energy converter 14 has an electrical power output capacity of no more than 5 kWe. In either case, it will be appreciated that the thermionic energy converter 14 (and, as a result, the module 10) is suited for use in a heating appliance such as, without limitation, a furnace, a boiler, or a water heater in settings such as a residence or a commercial building.

In various embodiments the hot shell 16 may be coated with a material that is configured to increase thermal emissivity, thereby increasing heat transfer to the thermionic energy converter 14. In such embodiments, the material may include any suitable material such as silicon carbide, carbon, an inorganic ceramic, a silicon ceramic, a ceramic metal composite, a carbon glass composite, a carbon ceramic composite, zirconium diboride, “black” alumina (aluminum oxide with addition of magnesium oxide), or a combination thereof. It will be appreciated that the material may be tuned or roughened to increase radiative heat transfer from the burner 12 to the hot shell 16.

Referring additionally to FIG. 2C, in various embodiments the hot shell 16 tapers from a thickness t₁ at an end 48 toward a thickness t₂ at an end 50. In such embodiments, the thickness t₂ is less thick than the thickness t₁. It will be appreciated that the thicker section of the hot shell 16 at the end 48 concentrates the heat near one side of the hot shell 16. The hot shell 16 tapers to a thin wall with the thickness t₂ that creates higher thermal resistance to reduce heat transfer between hot and cold sides while still being thick enough to allow electrical current to be carried across the thermionic energy converter 14.

Referring additionally to FIG. 2D, in some such embodiments the hot shell 16 may include an electrically conductive tile 52 that is arranged to face toward heat 20 from the burner 12. As shown in FIG. 2D, the electrically conductive tile 52 is disposed at the end 48 of the hot shell 16 and has the thickness t₁.

In such embodiments, the hot side of the tile 52 is oriented toward the flame and is heated by the flame. A heat exchanger may sit in the trenches between the tiles 52 or on the base of the tiles 52 (as shown in FIG. 2D). In some embodiments the tiles 52 can be arranged electrically in series. In some other embodiments the tiles 52 can be arranged electrically in parallel. In some other embodiments a combination of series and parallel electrical connections can be used. Series connection allows the voltage output to be increased by the added tiles 52 connected in series, while parallel electrical connection allows for higher output current and system redundancy. In such embodiments with parallel electrical connection, if one tile 52 fails then all the tiles 52 do not fail.

In various embodiments the tiles 52 may be arrayed in cross section around the heat source (flame, heat pipe, solid block of material) in a circular fashion (with an added curvature to the flame-facing hot-shell surface) or any polygonal shape—for example, square, hexagon, octagon for 4, 6, and 8 rows of tiles 52, respectively.

In various embodiments the heat-side facing part of the tiles 52 may have a flat shape or a concave bowl shape to better conform to the heat source or optimally transfer heat/radiation.

In various embodiments the spaces between the tiles 52 may be filled with an insulating material (like porous aluminum oxide or the like) to help keep the hot sides hot and to help prevent heat leakage between the tiles 52.

If it is desirable to transfer heat from the cold shell 18 to air, then the tiles 52 may be configured like fins (thereby tuning spacing and the like) to optimize air flow and/or heat transfer to the air.

Referring additionally to FIGS. 2E-2G, the hot shell 16 and/or the cold shell 18 may include fins 54.

In various embodiments the hot shell 16, the cold shell 18, and (when provided) the fins 40 (FIGS. 11 and 1J) and 54 (FIGS. 2E-2G) may be made from a material such as, without limitation, silicon carbide, an iron-chromium-aluminium alloy, a superalloy, MAX-phase alloy, alumina, zirconium diboride, or the like.

In various embodiments and referring additionally to FIGS. 2H-2J, the cold shell 18 may include one or more thermal transfer enhancement features such as divots 56 (FIG. 2H) defined in the cold shell 18, formed shapes 58 (FIG. 2I), and a thermal grease 60 (FIG. 2J) disposed on the cold shell 18. In applicable embodiments, the shapes 58 may be formed by any suitable process such as, without limitation, machining, die casting, stamping, or the like. It will be appreciated that the divots 56, the formed shapes 58, and the thermal grease 60 can help contribute to providing increased thermal contact and/or can help contribute to optimizing transfer of heat from the cold shell 18 to the heat exchanger 72. In some embodiments, the thermal grease 60 can help reduce air gaps or spaces (which act as thermal insulation) from the interface area in order to increase heat transfer and dissipation and can include metal like silver paste, organic, graphite, or the like. It will also be appreciated that the divots 56 and the formed shapes 58 can help contribute to conforming the cold shell 18 closely to the heat exchanger 72 and/or accommodating the form factor of the heat exchanger for mechanical stability.

It will be appreciated that various disclosed thermionic energy converters 14 can operate at lower hot side temperatures and lower cold side temperatures, thereby allowing use of more affordable ceramic components and also allowing for integration into water-based heat exchangers (because the heat rejection temperature is closer to the boiling point of water). This allows the thermionic energy converter 14 to potentially be immersed in water for more efficient water heating. However, it will be appreciated that many previously-known systems may be incompatible with direct water heating due to having the cold side at approximately 900 K.

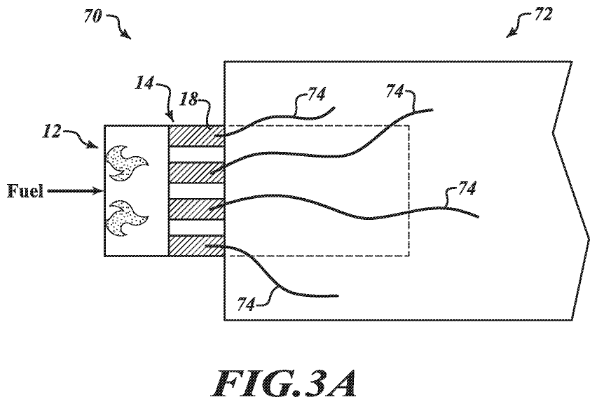

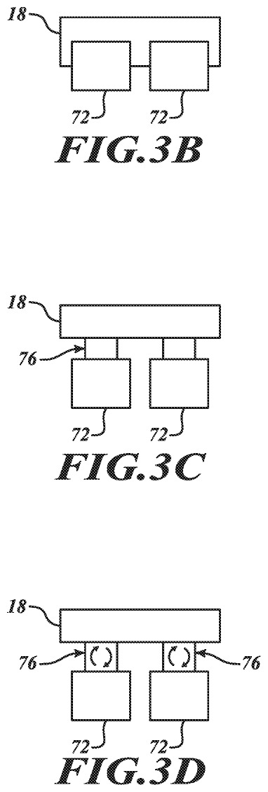

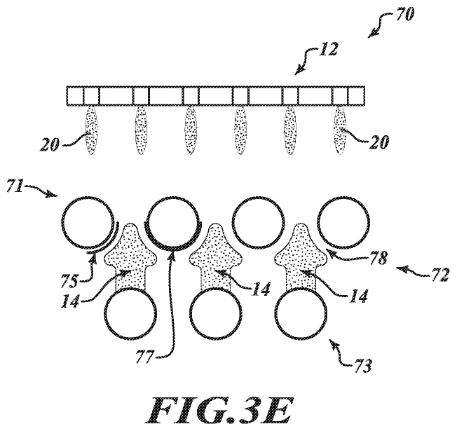

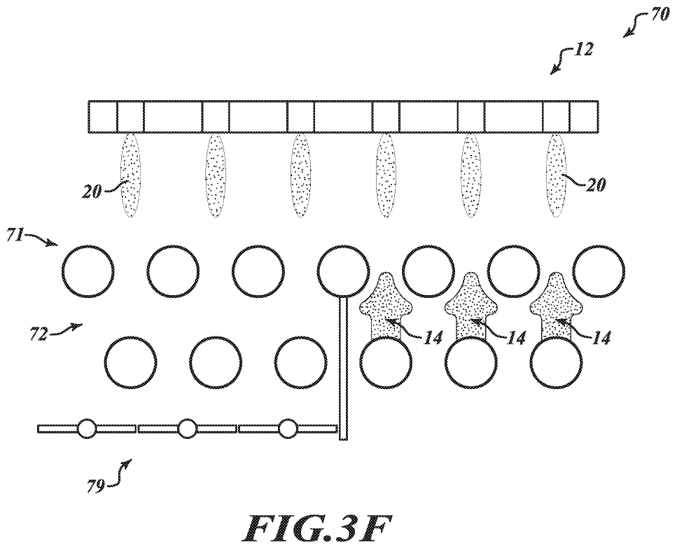

Referring additionally to FIG. 3A, in another illustrative embodiment a combined heat and power module 70 includes the burner 12. The thermionic energy converter 14 has the hot shell 16 and the cold shell 18, and the hot shell 16 is configured to be thermally couplable to the burner 12. A heat exchanger 72 is configured to be thermally couplable to the cold shell 18. Each one of the burner 12 and the thermionic energy converter 14 and the heat exchanger 72 is attached to at least one other of the burner 12 and the thermionic energy converter 14 and the heat exchanger 72.

The burner 12 and the thermionic energy converter 14 have been discussed in detail above and details of their construction and operation need not be repeated for an understanding by one of skill in the art. It will also be appreciated that heat exchangers are well known in the art and details of their construction and operation need not be discussed for an understanding by one of skill in the art.

It will be appreciated that, because the cold shell 18 is configured to be thermally couplable to the heat exchanger 72, the module 70 is suited for use in a heating appliance such as, without limitation, a furnace, a boiler, or a water heater in settings such as a residence or a commercial building, and can help contribute to increasing overall system efficiency by helping to use waste heat from the cold shell 18 (as indicated by arrows 74) that is thermally couplable to the heat exchanger 72 in a heating appliance.

In some embodiments the cold shell 18 and the heat exchanger 72 may be arranged such that the cold shell 18 and the heat exchanger 72 physically contact each other. Referring additionally to FIG. 3B, in some such embodiments the heat exchanger 72 may be closely geometrically coupled to the cold shell 18. In such embodiments, heat may be transferred from the cold shell 18 to the heat exchanger 72 via conduction, convection, and/or radiation.

However, it will be appreciated that the cold shell 18 and the heat exchanger 72 need not physically contact each other. To that end, in some other embodiments the cold shell 18 and the heat exchanger 72 are spaced apart from each other. That is, the cold shell 18 and the heat exchanger 72 may be arranged such that the cold shell 18 and the heat exchanger 72 do not physically contact each other. In such embodiments, heat may be transferred from the cold shell 18 to the heat exchanger 72 via convection and/or radiation.

Referring additionally to FIGS. 3C and 3D, in some such embodiments, a thermal coupler 76 may be disposed in thermal contact with the cold shell 18 and the heat exchanger 72. As shown in FIG. 3C, in some embodiments the thermal coupler 76 may include thermal interface material with appropriate thermal conductivity to transfer heat at the desired amount from the cold shell 18 to the heat exchanger 72. In some such embodiments the thermal interface material may be electrically insulating or electrically conducting. It will be appreciated that in various embodiments the thermal interface material may also be a piece of material (such as, for example, copper or other thermally conductive metals, thermally conductive metal alloys, thermally conductive ceramic, or the like) with thermal conductivity chosen to provide a desirable temperature distribution and heat transfer.

As shown in FIG. 3D, in some other embodiments the thermal coupler 76 may include a heat pipe. It will be appreciated that in embodiments that include thermal coupler 76 heat also may be transferred from the cold shell 18 to the heat exchanger 72 via conduction. In such embodiments, the heat pipe could be filled with a fluid, a mixture of fluids (such as water and glycol, or organic fluids like methanol or ethanol or naphthalene) or a metal (cesium, potassium, sodium, mercury, or a mixture of these). The heat pipe may be a grooved, mesh, wire, screen, or sintered heat pipe as desired for a particular application.

Referring additionally to FIG. 3E, in some embodiments the heat exchanger 72 may include a tube bank 71 and a tube bank 73. In such embodiments the thermionic energy converter 14 may be disposed intermediate the tube bank 71 and the tube bank 73. It will be appreciated that this arrangement helps enable potential integration of the thermionic energy converter 14 within tube banks of the heat exchanger 72 to increase flow velocity and heat transfer around the hot shell 16 and to reduce the view factor of the surface of the hot shell 16 to the burner 12. In some such embodiments the tubes of the tube bank 71 may include one or more features configured to reduce re-radiation from the thermionic energy converter 14, such as without limitation a re-radiation shield 75 and/or thermal insulation 77 disposed on a portion of an exterior surface of the tubes of the tube bank 71 that is proximate the thermionic energy converter 14. In some such embodiments the thermionic energy converter 14 may include one or more features configured to increase heat transfer to the thermionic energy converter 14, such as without limitation fins and/or a surface texture. In some other such embodiments width of a gap 78 between tubes of the tube bank 71 and the thermionic energy converter 14 may be optimized for flow conditions.

Referring additionally to FIG. 3F, in some embodiments a structure 102 may be configured to restrict exhaust from the burner 12 to portions of the heat exchanger 72 that are thermally couplable with the thermionic energy converter 14. It will be appreciated that it may not be desirable to use a thermal power turn-down ratio that is too large to avoid losing emitter temperature. However, in applications with larger turn-down ratios the structure 102 can block exhaust flow and guide the flow through bank(s) with the thermionic energy converters 14 or can restrict the exhaust gas flow through parts of the heat exchanger 72 without the thermionic energy converters 14.

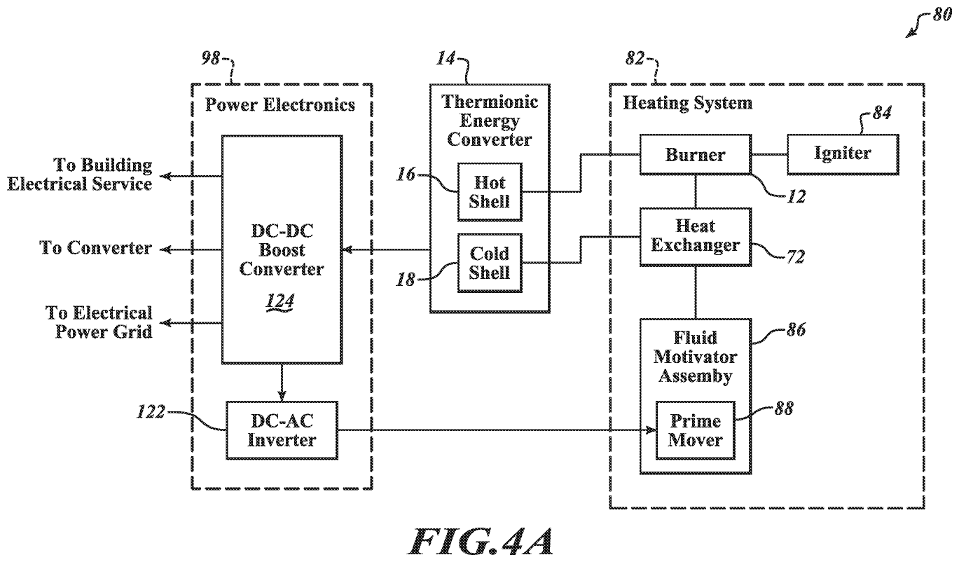

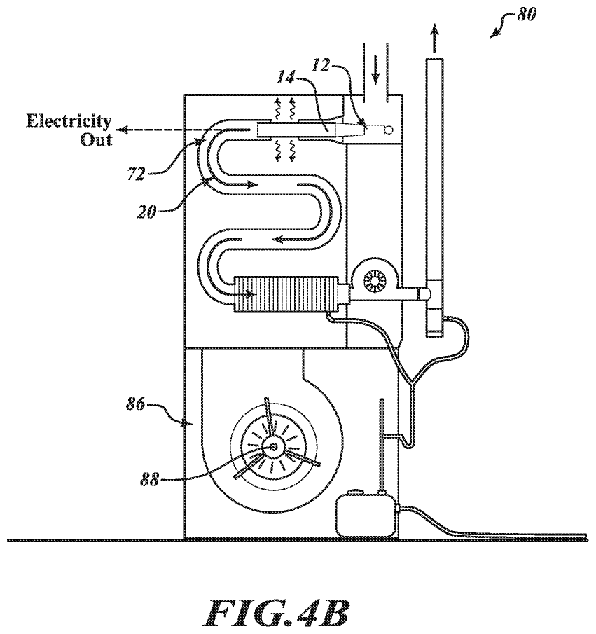

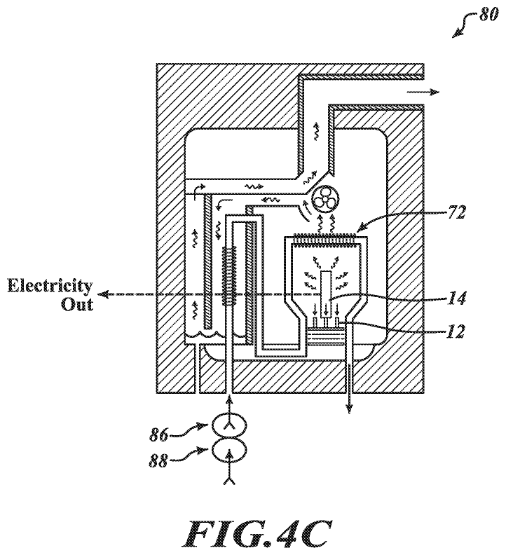

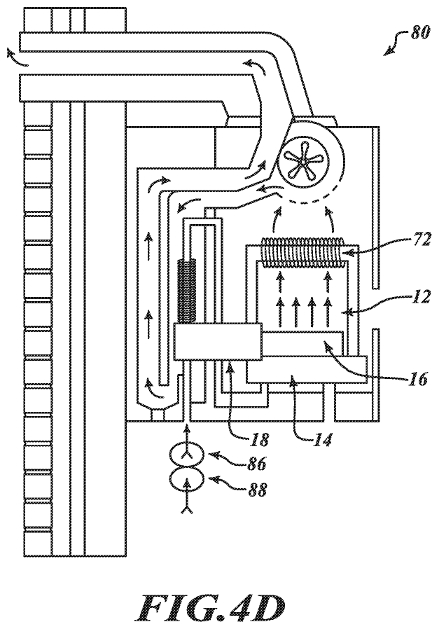

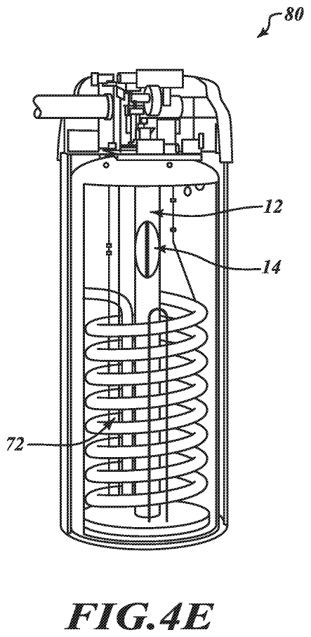

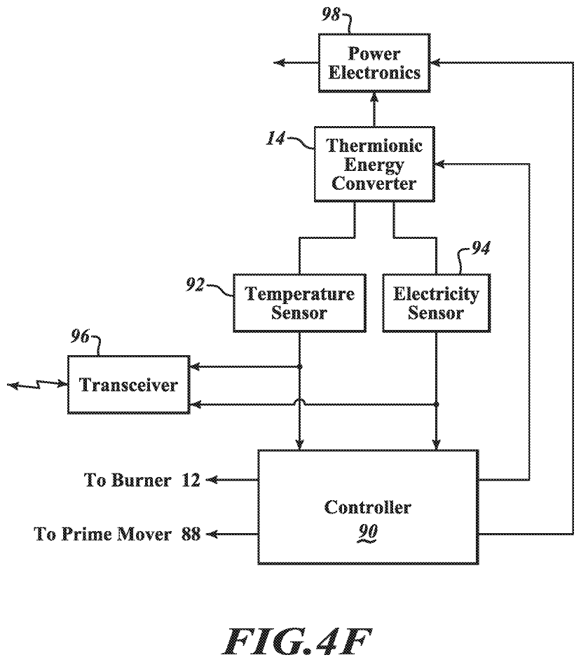

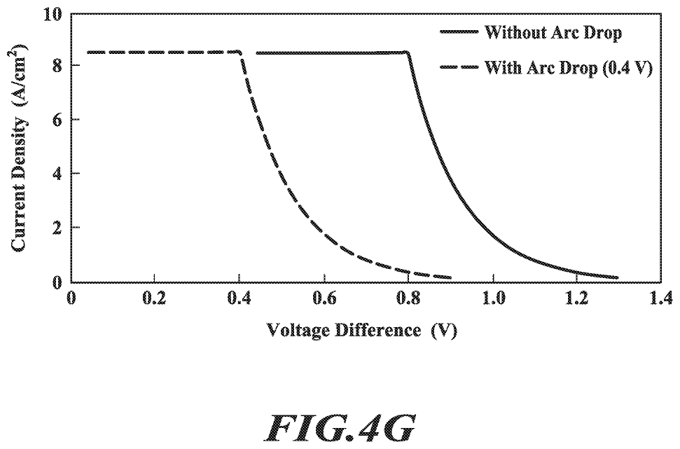

Referring additionally to FIG. 4A, in various embodiments a combined heat and power device 80 is provided. The combined heat and power device 80 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one thermionic energy converter 14 has a hot shell 16 and a cold shell 18. The hot shell 16 is thermally couplable to the burner 12 and the cold shell 18 is thermally couplable to the heat exchanger 72.

The burner 12 and the thermionic energy converter 14 have been discussed in detail above and details of their construction and operation need not be repeated for an understanding by one of skill in the art. It will also be appreciated that heat exchangers are well known in the art and details of their construction and operation need not be discussed for an understanding by one of skill in the art. Also, thermal coupling between burner 12 and the thermionic energy converter 14 and between the thermionic energy converter 14 and the heat exchanger 72 have been discussed in detail above and their details need not be repeated for an understanding by one of skill in the art.

In some embodiments the burner 12 and the thermionic energy converter 14 may be installed in the combined heat and power device 80 as the module 10. However, in some other embodiments the burner 12 and the thermionic energy converter 14 may be installed individually in the combined heat and power device 80. Similarly, in some embodiments heat exchanger 72 may be installed in the combined heat and power device 80 as part of the module 70. However, in some other embodiments the heat exchanger 72 may be installed individually in the combined heat and power device 80.

Referring additionally to FIGS. 4B-4E, in various embodiments the combined heat and power device 80 may include without limitation a heating appliance such as, for example, a furnace (FIG. 4B), a boiler (FIGS. 4C and 4D), or a water heater (FIG. 4E).

In embodiments in which the combined heat and power device 80 includes a furnace (FIG. 4B), the fluid motivator assembly 86 includes an air blower and the prime mover 88 includes a blower motor. Given by way of non-limiting example, the furnace may be a residential or commercial furnace that is used to heat and distribute air for heating a residence or other building. Furnaces are well known in the art and further details regarding their construction and operation are not necessary for an understanding of disclosed subject matter.

In embodiments in which the combined heat and power device 80 includes a boiler (FIGS. 4C and 4D) or a water heater (FIG. 4E), the fluid motivator assembly 86 includes a water circulator pump and the prime mover 88 includes a pump motor. Given by way of non-limiting example, the boiler may be a residential or commercial boiler that is used to heat water and distribute hot water and/or steam in a residence or other building. Given by way of non-limiting example, the water heater may be a residential or commercial water heater that is used to heat water and store hot water for use in a residence or other building. Boilers and water heaters are well known in the art and further details regarding their construction and operation are not necessary for an understanding of disclosed subject matter.

In embodiments in which the combined heat and power device 80 includes a boiler (FIGS. 4C and 4D) the boiler may be a conventional boiler (FIG. 4C) or a condensing boiler (FIG. 4D). In embodiments in which the combined heat and power device 80 includes a condensing boiler (FIG. 4D), the heat exchanger 72 also acts as a condenser that cools exhaust fumes which are saturated with steam and which condense into water in the liquid state, using the water from the heating system at low temperature (approximately 50° C.) circulating through it. The heat which the exhaust fumes transfer to the heat exchanger 72 in turn heats the water in the heating system.

Referring additionally to FIG. 4F, in various embodiments a controller 90 is configured to control the burner 12, the thermionic energy converter 14, and the prime mover 88. It will be appreciated that the controller 90 may be any suitable computer-processor-based controller known in the art. Illustrative functions of the controller 90 will be explained below by way of illustration and not of limitation.

In various embodiments a temperature sensor 92 is configured to sense temperature of the thermionic energy converter 14 and at least one electricity sensor 94 is configured to sense electrical output (that is, voltage and/or current) of the thermionic energy converter 14. Output signals from the temperature sensor 92 and the electricity sensor 94 are provided to the controller 90. In some embodiments output signals from the temperature sensor 92 and the electricity sensor 94 may be provided to a transceiver 96 that is configured to transmit and receive data regarding the temperature sensor 92 and the electricity sensor 94.

It will be appreciated that the combined heat and power device 80 enabled with the temperature sensor 92 and the electricity sensor 94 can collect data on heat and electricity output. It will also be appreciated that the controller 90 is configured to process the data for optimization. That is, the combined heat and power device 80 can draw inferences on the time-and-magnitude of usage patterns and can help toward optimizing its future behavior (for example, to pre-heat the building at predicted times—such as before an occupant or employee usually returns).

It will also be appreciated that the combined heat and power device 80 enabled with the temperature sensor 92 and the electricity sensor 94 can transmit data wirelessly to-and-from other electricity-consuming devices in the building (such as, for example, an electric car, air conditioner and HVAC, smart home hubs, smart home assistants, and the like) so that these devices can modulate their own or other device's utilization of electricity and so that the electricity and heat demand of the building more closely matches the supply of electricity and heat from the combined heat and power device 80.

It will also be appreciated that the combined heat and power device 80 enabled with the temperature sensor 92 and the electricity sensor 94 can transmit data wirelessly to-and-from the electric utility and/or regulator. As a result, electricity generation can be scheduled in advance or can be dispatched on command such that the produced electricity is fed in reverse through an electrical meter back onto the grid.

Finally, it will also be appreciated that output from a thermionic converter is a function of temperature of the active surfaces on the emitter (hot shell) and collector. Over time, the performance of a boiler and gas furnace is reduced because of changes in the combustion system and heating surface—for instance because of fouling of components. Multiple components may be susceptible to these degradations. In the combustion system, for example, degradation of the blower can reduce combustion air flow. This reduction in combustion air flow may increase the flame temperature and, as a result, the power output from the thermionic converter. In the heat exchanger, fouling of the heating surfaces lowers the temperature of the heating fluid because the total heat transfer is lowered. Additionally, the heat up rate of the building or hot water supply is impacted by changes to these system components. After prolonged use of the combined heat and power device 80, the time it will take the combined heat and power device 80 to heat the heating fluid will change. Because the thermionic energy converter 14 is connected to both the heating and cooling portion of the combined heat and power device 80, the degradation of the heating demand response can be determined without the use of any thermocouples. As is known, thermocouples only measure a local temperature—whereas thermionic converters provide a more global visibility of the impact on temperature variations. In some systems, then, the temperature monitoring of the system can be enhanced with monitoring the performance of the thermionic energy converter 14 instead of or in addition to the use of thermocouples or other sensors.

In various embodiments the controller 90 is further configured to modulate electricity output from the thermionic energy converter 14. In some such embodiments the controller 90 modulates electricity output from the thermionic energy converter 14 based upon an attribute such as a number of burners 12 and/or a number of thermionic energy converters 14. For example, in some embodiments the combined heat and power device 80 may include multiple burners 12 and multiple thermionic energy converters 12, and one or more of the burners 12 may not be thermally coupled to any of the thermionic energy converters 12. In some such embodiments the controller 90 is further configured to turn on burners 12 that are thermally coupleable to thermionic energy converters 14 before turning on burners 12 that are not thermally coupleable to thermionic energy converters 14. Likewise, in some embodiments the controller 90 is further configured to turn off burners 12 that are not thermally coupleable to thermionic energy converters 14 before turning off burners 12 that are thermally coupleable to thermionic energy converters 14. It will be appreciated that such a scheme increases utilization time and can help spread out the occurrence of wear and tear on each individual thermionic energy converter 14, thereby helping contribute to prolonging overall system lifetime.

In various embodiments the controller 90 is configured to modulate electrical power output of the thermionic energy converter 14 at a power point that differs from a maximum power/efficiency point on a current-voltage profile of the thermionic energy converter 14. It will be appreciated that boiler and furnace applications of thermionic converters is that heating systems such as boilers and furnaces typically do not operate at maximum thermal power output conditions. To avoid overheating or a detrimental drop in emitter temperature (quenching electrical power production) and referring additionally to FIG. 4G, thermionic converters have the ability to vary the heat flux through the device by operating the converter at a different power point (other than maximum power/efficiency point) on its current-voltage or IV curve (as shown in FIG. 4G). The electrons traversing the gap not only carry charge but also thermal energy with them. Based on ideal diode calculations the heat flux transported through the thermionic converters can be reduced by a factor of 2. Thus reduction drops the power output density and the efficiency. For instance, the heat flux can be reduced by a factor of 2 while the electrical power density drops from ˜3 W/cm2 to 1 W/cm2 and efficiency drops from ˜11% to ˜7%. Thus, from the perspective of overall system performance the thermionic converter cell operation can be optimized for a different power point to enable a range of thermal power output.

In some embodiments the controller 90 may be further configured to modulate the burner 12 (also known as “turndown”) when little heat is desired. In such embodiments, the burner 12 can modulate/turndown up to N:1 (that is, operate at 1/N its rated capacity). In some embodiments, the burner 12 may include multiple sub-burners. One or more of these sub-burners can be thermally couplable to a thermionic energy converter 14. The burner 12 with the thermionic energy converter 14 could operate at 1/N of its rated capacity and keep the thermionic energy converter 14 hot, thereby generating electricity the entire time, thereby resulting in a higher utilization rate. In such embodiments the controller 90 may be further configured to turn all burners 12 at maximum capacity to provide desired heating quickly. Then, when the desired temperature is reached and less heat is desired, the controller 90 turns off all but one burner 12 which stays on preferentially to keep the thermionic energy converter 14 hot, thereby generating electricity the entire time and resulting in a higher utilization rate.

In some embodiments the controller 90 can be configured for multi-cell thermionic modulation. For example, there may be instances in which less electricity is needed at a given time, or it is cheaper to buy electricity from the grid, or batteries are fully charged (or some other scenario where it is not desired to generate electricity with the thermionic energy converter 14). A thermionic converter including several thermionic energy converters 14 (N cells in series) in parallel can turn off some fraction of the thermionic energy converters 14 by applying a negative voltage to the anode (thus suppressing electron emission and power generation).

Thus, it will be appreciated that modulation can help contribute to matching demand in the building (as indicated by a smart home-type controller that may or may not be connected to receive information about energy use in the building or on the electricity or fuel grids). It will also be appreciated that modulation can help contribute to tuning the heat:electricity ratio and can turn up/down depending on the amount of heat desired. It will also be appreciated that modulation can help increase (with a goal of maximizing) economic return, such as by turning on only a burner 12 with an associated thermionic energy converter 14 to sell electricity back to the larger electricity grid (if heat is not desired but the goal is to maximize money) and excess heat could be stored in a tank/storage battery of some sort (such as a hot water tank).

In various embodiments power electronics 98 are electrically coupled to the thermionic energy converter 14. In various embodiments the power electronics 98 is configured to boost DC voltage (via a DC-DC boost converter 124) and/or invert DC electrical power to AC electrical power (via a DC-AC inverter 122). Because output voltage from the thermionic energy converter 14 is relatively low, the power electronics 98 boost output voltage from the thermionic energy converter 14 to useful voltages. The DC-AC inverter 122 transforms the boosted DC voltage to an AC voltage in order to export power to the building, or to run AC driven boiler/furnace components, or to transfer power to the local electrical grid outside the building.

In various embodiments inlet air to the burner 12 and/or inlet fuel to the burner 12 may be pre-heated. In some embodiments the power electronics 98 is disposed in thermal communication with inlet air to the burner 12 and/or inlet fuel to the burner 12. Loss of efficiency in the power electronics 98 can be recovered by using inlet air to the burner 12 and/or inlet fuel to the burner 12 as a cooling stream for the power electronics 98. Lost heat will then be passed into the intake stream, which preheats it and is recovered. By locating the power electronics 98 in or near the incoming stream of air and/or fuel, the heat lost in the power electronics 98 can be used to preheat the intake air, thereby recapturing some of this energy that would otherwise be lost.

In some embodiments a recuperator 100 is configured to pre-heat inlet air to the burner 12 and/or inlet fuel to the burner 12 with exhaust gas from the burner 12.

In various embodiments the combined heat and power device 80 is configured to be electrically couplable to an electrical bus transfer switch.

In various embodiments a resistive heating element is electrically connectable to the thermionic energy converter 14. In some embodiments it may be desirable to use the excess power that is produced by the thermionic energy converter 14 (that is, electricity produced in excess to the load demand by the building grid) and send that power to a resistive heater. It will be appreciated that the full energy production potential from the thermionic energy converter 14 may be substantially used and that modulation is not required.

In various embodiments the combined heat and power device 80 can be operated to produce higher electricity output to meet high electricity demand. In some of these cases, more heat may be generated than is desired at a given time. In such instances, the excess heat can be handled by at least the following: (i) attach a hot water tank to take the excess heat, thereby storing the heat for space heating or hot water that can be delivered later; (ii) attach phase change material to take some of the excess heat, thereby storing the heat for space heating or hot water than can be delivered later; (iii) attach an absorption cycle cooling system to take the excess heat and generate cooling; (iv) transmitting a signal to the building air duct system, which can open-or-close an opening to allow the heated air to partially flow outside the building; and (v) direct the excess heat flow into the flue gas exhaust tube of the combined heat and power device 80 via a controllable valve.

In various embodiments the combined heat and power device 80 can help to provide accelerated heating. For example, in such embodiments the thermionic energy converter 14 can switch from a default mode of converting heat into electricity and go into a mode of converting electricity into heat. In the latter mode, the thermionic energy converter 14 draws electrical power from a building's electrical system and sets the electron collector electrode (anode) of the thermionic energy converter 14 to a voltage bias that is positive with respect to the electron emitter electrode (cathode) by a voltage difference of +1 V to +10,000 Volt. Electrons emitted by the cathode will therefore be accelerated and impact the electron collector at higher energies, thereby resulting in efficiency heating of the electron collector. This will allow for higher heat output from the combined heat and power device 80 than that which was possible from burning natural gas or propane alone, thereby enabling the combined heat and power device 80 to deliver higher heat per unit time to the user—which could be helpful when the user wants to ramp the temperature quickly.

It will also be appreciated that the combined heat and power device 80 can use external data including weather, real-time and future (day-ahead) energy market prices, utility generation forecast, demand forecast data, or externally- (cloud-) computed algorithms based on such data to help optimize use of the thermionic energy converter 14 or to help create optimized economic value for the owner of the building or external parties (such as utilities or energy service companies).

It will also be appreciated that multiple combined heat and power devices 80 (such as in different buildings and/or across geographies) can be aggregated and controlled (either through the internet and/or wireless networks) in tandem to provide grid ancillary services that can help contribute to offering more value to utilities and grid operators than a single combined heat and power device 80 alone. For example, a utility seeing a dangerous spike in energy demand on a specific substation could switch on and control all thermionic devices in the distribution grid for that substation, thereby reducing demand for each home and, thus, reducing the load on the substation or distribution grid. Similarly, other grid services may be provided, including capacity, voltage and frequency response, operating reserves, black start, and other compensated services.

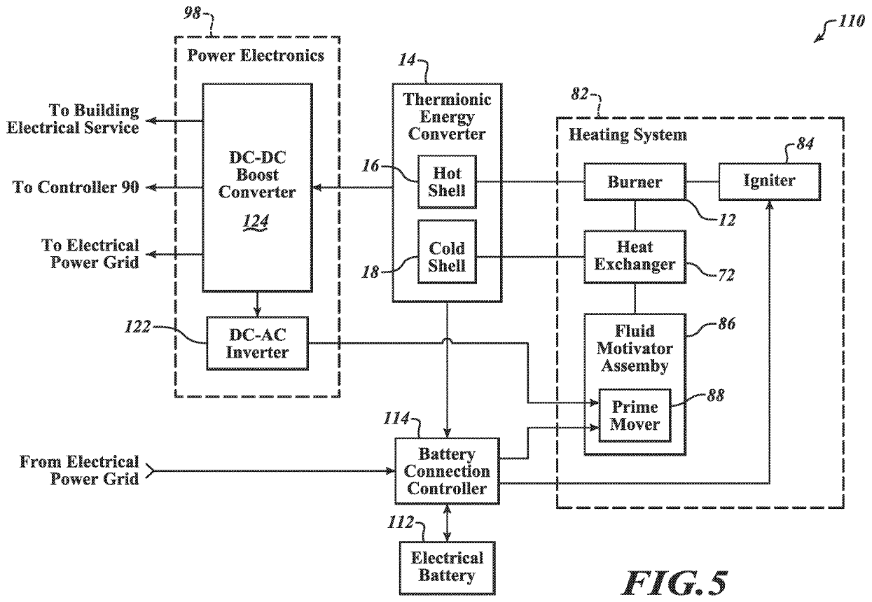

Referring additionally to FIG. 5, in various embodiments a combined heat and power device 110 may provide a backup generator. In such embodiments the combined heat and power device 110 can turn on in case of electrical grid outage to provide electrical power. It will be appreciated that the gas grid does not go out, whereas the combined heat and power device 110 may be coupled with a transfer switch to electrical systems in the building. Thus, electrical power from the thermionic energy converter 14 can power the electricity-consuming components of the combined heat and power device 110 itself (such as controls, motors, blowers, sensors, and the like) during an electrical power outage.

In such embodiments, the combined heat and power device 110 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one thermionic energy converter 14 has a hot shell 16 and a cold shell 18. The hot shell 16 is thermally couplable to the burner 12 and the cold shell 18 is thermally couplable to the heat exchanger 72. An electrical battery 112 is electrically connectable to the igniter 84 and the prime mover 88 and system controls.

From a cold start, the electrical battery 112 powers the igniter 84 and the prime mover 88 and system controls. After startup, the thermionic energy converter 14 powers the prime mover 88 and system controls and recharges the electrical battery 112.

In some embodiments a battery connection controller 114 is configured to electrically connect the electrical battery 112 to the igniter 84 and the prime mover 88 and system controls. In some such embodiments the battery connection controller 114 may be further configured to electrically connect the electrical battery 112 to the igniter 84 and the prime mover 88 and system controls automatically in response to loss of electrical power from an electrical power grid. In some other such embodiments the battery connection controller 114 may be further configured to electrically connect the electrical battery 112 to the igniter 84 and the prime mover 88 and system controls manually by actuation by a user.

In some embodiments the battery connection controller 114 may be further configured to electrically connect the electrical battery 112 to the thermionic energy converter 14 to charge the electrical battery 112.

In some embodiments the heat exchanger 72 may be configurable to direct fluid disposed therein to an interior environment of a building, ambient environment exterior a building, and/or a thermal storage reservoir, such as for example a water tank.

Thus, in such embodiments, as long as the gas supply is steady (which is more reliable than the electrical grid), the combined heat and power device 110 can run on electrical power from the thermionic energy converter 14 alone. It will be appreciated that the thermionic energy converter 14 is to be sized to power all of the electrical loads of the combined heat and power device 110. Given by way of non-limiting examples, these electrical loads can be in a range of less than 50 W, between 50 W and 200 W, or in some cases more than 200 W—depending on the size and power draws of various components.

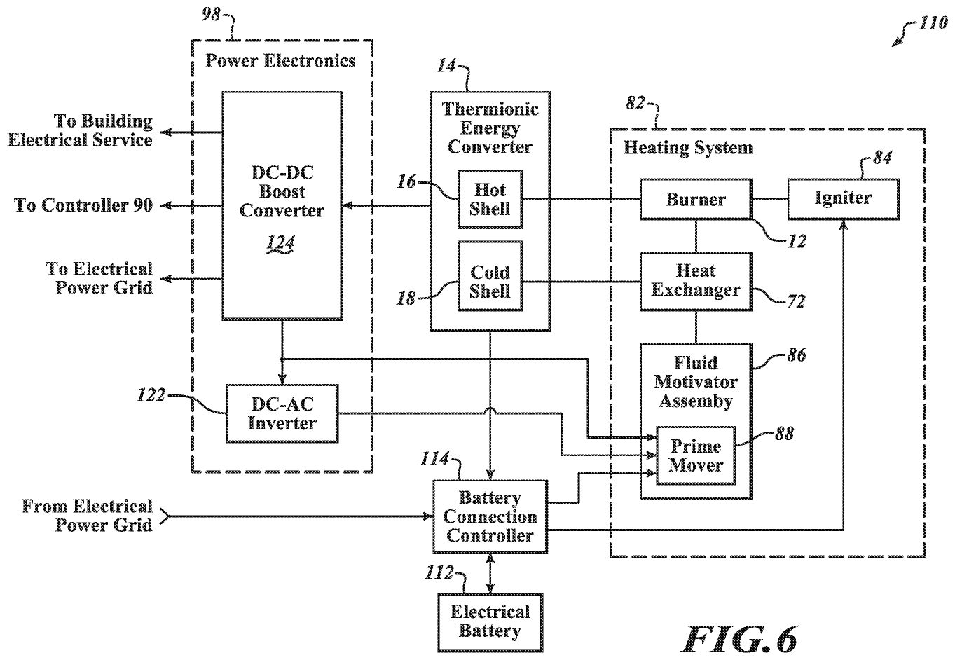

Referring additionally to FIG. 6, in various embodiments a combined heat and power device 120 may provide a self-powering appliance, such as a furnace, a boiler, or a water tank. It will be appreciated that use as self-powering boiler or furnace can help contribute to resulting in a lower utility bill and/or a furnace and/or boiler that still works when electrical grid (or other) power goes out. Generally, the thermionic energy converter 14 can be incorporated into a boiler or furnace and the electricity generated thereby can be used to power these heating appliances, so that they can operate even if there was no external electricity delivered to the unit (for example, during an electrical grid blackout). Also, electrical power from the thermionic energy converter 14 could be used to directly drive motors, blowers, control units, pumps, fans, and the like rather than pulling this electrical power from the electrical supply grid, thereby reducing electrical consumption from the electrical supply grid and increasing energy ratings and offsetting electrical power that previously had to be purchased from the electrical supply grid (thereby helping contribute to lowering utility bills).

The electrical components of the combined heat and power device 120 typically range from less than 100 Watts of electrical power, between 100 W and 300 W, or in some cases more than 300 W depending on the size and power requirements of various components (blowers, fans, electronic controls, and the like). By incorporating the thermionic energy converter 14 into the combined heat and power device 120 and interfacing with the burner 12, illustrative disclosed thermionic energy converters 14 can help provide enough power to help keep the combined heat and power device 120 running without any external grid electricity.

In this scenario, the power output from the TEC can be conditioned using a combination of DC-DC boost converters (for DC components like control boards) and/or inverters (for AC components like some motors) and similar power electronics. In many newer furnaces, DC motors are replacing AC motors in which case an inverter may not be required. In any case, it is important that the thermionic needs to be sized to power all of the electrical needs of the heating appliance. This can be as in a range of less than 100 Watts of electrical power, between 100 W and 300 W or in some cases more than 300 W depending on the size and power requirements of the boiling components (blowers, fans, electronic controls, etc.)

In various embodiments, the combined heat and power device 120 includes a heating system 82. The heating system 82 includes at least one burner 12, at least one igniter 84 configured to ignite the at least one burner 12, a fluid motivator assembly 86 including an electrically powered prime mover 88, and the heat exchanger 72 fluidly couplable to the fluid motivator assembly 86. At least one thermionic energy converter 14 has a hot shell 16 and a cold shell 18. The hot shell 16 is thermally couplable to the burner 12 and the cold shell 18 is thermally couplable to the heat exchanger 72. The thermionic energy converter 14 is electrically couplable to the prime mover.

In some embodiments, the combined heat and power device includes a DC-AC inverter 122. In such embodiments, the prime mover 88 includes an AC motor and the prime mover 88 is electrically coupled to receive AC electrical power from the DC-AC inverter 122.

In some embodiments, the combined heat and power device includes a DC-DC boost converter. In such embodiments the controller 90 (FIG. 4F) is configured to control the burner 12, the thermionic energy converter 14, and/or the prime mover 88. The controller 90 is electrically coupled to receive DC electrical power from the DC-DC boost converter 124. Also, in some embodiments for furnace applications, the fluid motivator assembly 86 may include a direct-current electric fan as the blower assembly and the prime mover 88 may include a direct-current blower motor (instead of the usual alternating-current ones). In such embodiments, the direct-current electricity output of the thermionic energy converter 14 is transformed via the power electronics 98 and the DC-DC boost converter 124 to a different voltage that is used to drive the direct-current electric fans.

In various embodiments, electrical power output of the thermionic energy converter 14 is at least 100 W.

In some embodiments the combined heat and power device includes the electrical battery 112. In such embodiments the battery connection controller 114 is configured to electrically connect the electrical battery 112 to the igniter 84 and the prime mover 88. In some such embodiments the battery connection controller 114 may be further configured to electrically connect the electrical battery 112 to the thermionic energy converter 14 to charge the electrical battery 112.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A combined heating and power module comprising:
at least one burner; and
at least one thermionic energy converter attached to the at least one burner, the at least one thermionic energy converter having a hot shell and a cold shell, the hot shell being configured to be thermally couplable to the at least one burner, the cold shell being configured to be thermally couplable to a heat exchanger.

2. The combined heating and power module of claim 1, wherein the at least one burner includes a burner chosen from a nozzle burner and a venturi burner.

3. The combined heating and power module of claim 2, wherein:
the burner includes a first-pass tube and a second pass tube interconnected by an elbow; and
the thermionic energy converter is disposed in the elbow.

4. The combined heating and power module of claim 1, wherein the at least one burner includes a single-ended recuperative burner.

5. The combined heating and power module of claim 1, wherein the at least one burner includes a porous burner.

6. The combined heating and power module of claim 1, wherein the at least one burner includes no more than one burner.

7. The combined heating and power module of claim 1, wherein the at least one burner includes a plurality of burners.

8. The combined heating and power module of claim 1, wherein the at least one burner is configured to combust using an enrichment agent chosen from oxygen-enriched air and hydrogen-enriched combustion.

9. The combined heating and power module of claim 1, wherein exhaust gas from the at least one burner is directable over surfaces of the at least one thermionic energy converter more than one time.

10. The combined heating and power module of claim 9, wherein the at least one burner is arranged such that exhaust gas from the at least one burner is directable over surfaces of the at least one thermionic energy converter more than one time.

11. The combined heating and power module of claim 9, further comprising:
a swirler configured to direct exhaust gas from the at least one burner over surfaces of the at least one thermionic energy converter more than one time.

12. The combined heating and power module of claim 1, wherein the at least one burner is configured for substantially stoichiometric combustion.

13. The combined heating and power module of claim 1, wherein at least a portion of a component chosen from the hot shell and a component thermally coupled to the hot shell is located in an exhaust stream from the at least one burner.

14. The combined heating and power module of claim 1, wherein the at least one thermionic energy converter includes:
a vacuum envelope; and
a cesium reservoir.

15. The combined heating and power module of claim 1, wherein the at least one thermionic energy converter has an electrical power output capacity of no more than 50 KWe.

16. The combined heating and power module of claim 15, wherein the at least one thermionic energy converter has an electrical power output capacity of no more than 5 KWe.

17. The combined heating and power module of claim 1, wherein the hot shell is coated with a material configured to increase thermal emissivity.

18. The combined heating and power module of claim 17, wherein the material includes a material chosen from at least one of silicon carbide, carbon, an inorganic ceramic, a silicon ceramic, a ceramic metal composite, a carbon glass composite, a carbon ceramic composite, zirconium diboride, and aluminum oxide with addition of magnesium oxide.

19. The combined heating and power module of claim 1, wherein the hot shell tapers from a first thickness at one end thereof toward a second thickness at a second end thereof, the second thickness being less thick than the first thickness.

20. The combined heating and power module of claim 1, wherein the hot shell includes an electrically conductive tile arranged to face toward heat from the at least one burner.

21. The combined heating and power module of claim 1, wherein at least one shell chosen from the hot shell and the cold shell includes a plurality of fins.

22. The combined heating and power module of claim 1, wherein at least one shell chosen from the hot shell and the cold shell is made from a material chosen from silicon carbide, an iron-chromium-aluminium alloy, a superalloy, a MAX-phase alloy, alumina, and zirconium diboride.

23. The combined heating and power module of claim 1, wherein the cold shell includes at least one thermal transfer enhancement feature chosen from a plurality of divots defined in the cold shell, a plurality of formed shapes, and a thermal grease disposed on the cold shell.

24. A combined heating and power module comprising:
at least one burner;
at least one thermionic energy converter, the at least one thermionic energy converter having a hot shell and a cold shell, the hot shell being configured to be thermally couplable to the at least one burner; and
a heat exchanger, the heat exchanger being configured to be thermally couplable to the cold shell, each one of the at least one burner and the at least one thermionic energy converter and the heat exchanger being attached to at least one other of the at least one burner and the at least one thermionic energy converter and the heat exchanger.

25. The combined heating and power module of claim 24, wherein the at least one burner includes a burner chosen from a nozzle burner and a venturi burner.

26. The combined heating and power module of claim 25, wherein:
the burner includes a first-pass tube and a second pass tube interconnected by an elbow; and
the thermionic energy converter is disposed in the elbow.

27. The combined heating and power module of claim 24, wherein the at least one burner includes a single-ended recuperative burner.

28. The combined heating and power module of claim 24, wherein the at least one burner includes a porous burner.

29. The combined heating and power module of claim 24, wherein the at least one burner includes no more than one burner.

30. The combined heating and power module of claim 24, wherein the at least one burner includes a plurality of burners.

31. The combined heating and power module of claim 24, wherein the at least one burner is configured to combust using an enrichment agent chosen from oxygen-enriched air and hydrogen-enriched combustion.

32. The combined heating and power module of claim 24, wherein exhaust gas from the at least one burner is directable over surfaces of the at least one thermionic energy converter more than one time.

33. The combined heating and power module of claim 32, wherein the at least one burner is arranged such that exhaust gas from the at least one burner is directable over surfaces of the at least one thermionic energy converter more than one time.

34. The combined heating and power module of claim 32, further comprising:
a swirler configured to direct exhaust gas from the at least one burner over surfaces of the at least one thermionic energy converter more than one time.

35. The combined heating and power module of claim 24, wherein the at least one burner is configured for substantially stoichiometric combustion.

36. The combined heating and power module of claim 24, wherein at least a portion of a component chosen from the hot shell and a component thermally coupled to the hot shell is located in an exhaust stream from the at least one burner.

37. The combined heating and power module of claim 24, wherein the at least one thermionic energy converter includes:
a vacuum envelope; and
a cesium reservoir.

38. The combined heating and power module of claim 24, wherein the at least one thermionic energy converter has an electrical power output capacity of no more than 50 KWe.

39. The combined heating and power module of claim 38, wherein the at least one thermionic energy converter has an electrical power output capacity of no more than 5 KWe.

40. The combined heating and power module of claim 24, wherein the hot shell is coated with a material configured to increase thermal emissivity.

41. The combined heating and power module of claim 40, wherein the material includes a material chosen from at least one of silicon carbide, carbon, an inorganic ceramic, a silicon ceramic, a ceramic metal composite, a carbon glass composite, a carbon ceramic composite, zirconium diboride, and aluminum oxide with addition of magnesium oxide.

42. The combined heating and power module of claim 24, wherein the hot shell tapers from a first thickness at one end thereof toward a second thickness at a second end thereof, the second thickness being less thick than the first thickness.

43. The combined heating and power module of claim 24, wherein the hot shell includes an electrically conductive tile arranged to face toward heat from the at least one burner.

44. The combined heating and power module of claim 24, wherein at least one shell chosen from the hot shell and the cold shell includes a plurality of fins.

45. The combined heating and power module of claim 24, wherein at least one shell chosen from the hot shell and the cold shell is made from a material chosen from silicon carbide, an iron-chromium-aluminium alloy, a superalloy, a MAX-phase alloy, alumina, and zirconium diboride.

46. The combined heating and power module of claim 24, wherein the cold shell includes at least one thermal transfer enhancement feature chosen from a plurality of divots defined in the cold shell, a plurality of formed shapes, and a thermal grease disposed on the cold shell.

47. The combined heating and power module of claim 24, wherein the cold shell and the heat exchanger physically contact each other.

48. The combined heating and power module of claim 24, wherein the cold shell and the heat exchanger are spaced apart from each other.

49. The combined heating and power module of claim 48, further comprising:
at least one thermal coupler chosen from thermal interface material disposed in thermal contact with the cold shell and the heat exchanger and a heat pipe disposed in thermal contact with the cold shell and the heat exchanger.

50. The combined heat and power module of claim 24, wherein:
the heat exchanger includes a first tube bank and a second tube bank; and
the at least one thermionic energy converter is disposed intermediate the first tube bank and the second tube bank.

51. The combined heat and power module of claim 50, wherein the tubes of the first tube bank include at least one feature configured to reduce re-radiation from the at least one thermionic energy converter, the at least one feature including a feature chosen from a re-radiation shield and thermal insulation disposed on a portion of an exterior surface of the tubes of the first tube bank that is proximate the at least one thermionic energy converter.

52. The combined heat and power module of claim 50, wherein the at least one thermionic energy converter includes at least one feature configured to increase heat transfer to the thermionic energy converter, the at least one feature including a feature chosen from a plurality of fins and a surface texture.

53. The combined heat and power module of claim 24, further comprising:
a structure configured to restrict exhaust from the at least one burner to portions of the heat exchanger that are thermally couplable with the at least one thermionic energy converter.

54.-121. (canceled)
